(19) United States
(12) Patent Application Publication
(10) Pub. No.: US 2017/0089445 A1
(43) Pub. Date: Mar. 30, 2017

(54) Differential housing

(71) Applicant: Dimitris Korres, Athens (GR)

(72) Inventor: Dimitris Korres, Athens (GR)

(21) Appl. No.: 15/282,708

(22) Filed: Sep. 30, 2016

Related U.S. Application Data
(60) Provisional application No. 62/235,558, filed on Sep. 30, 2015.

(51) Int. Cl. F16H 57/037; F16H 57/021

(52) U.S. Cl. CPC F16H 57/037; F16H 57/021

(57) ABSTRACT

A differential housing in which the differential is mounted on the side of the crown wheel through a spacer on the outer ring of a large diameter tapered roller bearing, which in turn is connected to a conical component. The conical component optionally configure to accommodate a constant velocity joint or a universal joint. The design allows for the use of a longer half shaft without changing the position of the engine or the central prop shaft.

### FIELD OF ART

The disclosed device generally relates to the automotive field, and more specifically to an improved eccentrically placed differential housing.

### BACKGROUND

The front differential on four-wheel-drive off-road vehicles is typically placed eccentrically, for spatial arrangement reasons, due to the position of the engine. A typical arrangement with the differential off-set with respect to the center line of the vehicle is shown in FIG. 1 (prior art) and is commonly understood by one skilled in the art.

These typical configurations result in a shorter distance between the differential and the adjacent wheel. Because of this a short half shaft for connecting to the wheel is required. The short half shaft length in combination with the constrained operating angle of the continuous velocity or universal joint limits the range of the wheel travel. FIG. 2 (prior art) illustrates the limited wheel travel that results from the need to use a short half shaft as is known in the industry.

In addition to limiting wheel travel, the need to use a short half shaft in typical arrangements negatively impacts the performance of a vehicle in other ways. Constant velocity joints and universal joints transfer power less efficiently as their operating angles increase. With a short half shaft length displacements of the wheel result in larger operating angles as compared to the operating angles when a longer half shaft is used. Shortening the half shaft length also reduces the torsional ductility of the half shaft. This is disadvantageous as torsional ductility of the half shaft is an important factor in protecting the transmission. For these reasons there is a need in the automotive field for an improved eccentrically placed differential housing that allows for a longer half shaft to be used.

### SUMMARY OF THE DISCLOSURE

In the device disclosed herein, the differential housing is mounted on the side of the crown wheel through a spacer on the outer ring of the large diameter tapered roller bearing. The large diameter tapered roller bearing is in turn connected to a conical component of the differential housing. In the device disclosed herein the conical component of the differential housing can be configured to accommodate a constant velocity joint or a universal joint.

The crown wheel is affixed, i.e., bolted on the spacer and the conical component comprises a thread to regulate the correct tooth mesh of the crown wheel and pinion gears.

With the disclosed differential housing design it is possible to use a longer half shaft without changing the position of the engine and without changing the position of the central propeller shaft (or “prop shaft”).

### BRIEF DESCRIPTION OF THE FIGURES

FIG. 1 (prior art) depicts a plan view of a typical arrangement of an eccentrically placed differential showing an engine (100), a propeller shaft (110), an inner constant velocity joint (120), a differential housing extension (130), a half shaft (140), a tapered roller bearing (150), a tapered roller bearing housing (160), and vehicle wheels (170).

FIG. 2 (prior art) depicts a horizontal view of a typical arrangement of an eccentrically placed differential in relation to the maximum vertical wheel displacement (D1) and the maximum operating angle (A1) of the constant velocity joint in the arrangement.

FIG. 3 is a plan view depicting one arrangement of the disclosed device.

FIG. 4 is a horizontal view of the arrangement of FIG. 3, and which depicts an eccentrically placed differential in relation to the maximum vertical wheel displacement (D2) and the maximum operating angle (A2) of the constant velocity joint.

FIG. 5 is an enlarged view of FIG. 3, the disclosed arrangement showing an engine (200), a prop shaft (210), a pinion gear (220), a main part (230) of a differential housing (1), a conical component (240) of the differential housing, a constant velocity joint (250), a large tapered roller bearing (260) with an outer ring (270) and an inner fixed ring (280), a crown wheel (290), a crown wheel spacer (300), and a group of planet and satellite gears (310), a tapered roller bearing (320), and a tapered roller bearing housing (330).

### DETAILED DESCRIPTION OF THE DISCLOSURE

As disclosed, a main part (230) of differential housing (1) is mounted on the side of crown wheel (290) through a crown wheel spacer (300) on an outer ring (270) of large diameter tapered roller bearing (260). Inner fixed ring (280) of large diameter tapered roller bearing (260) is in turn connected to a conical component (240) of differential housing (1). In the disclosed device, conical component (240) of differential housing (1) can be configured to accommodate a constant velocity joint (250) or a universal joint (not shown).

Crown wheel (290) is affixed, i.e., bolted on crown wheel spacer (300) and conical component (240) of differential housing (1) has a thread to regulate the tooth mesh of crown wheel (290) and pinion gear (220).

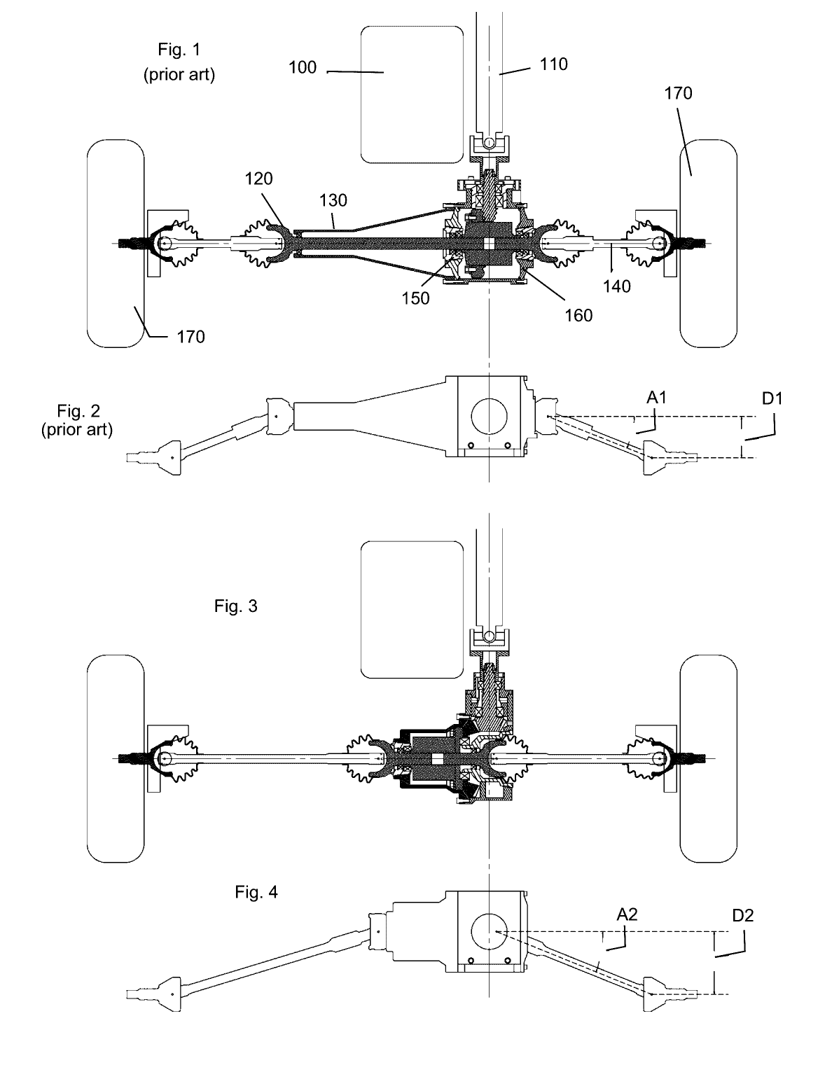

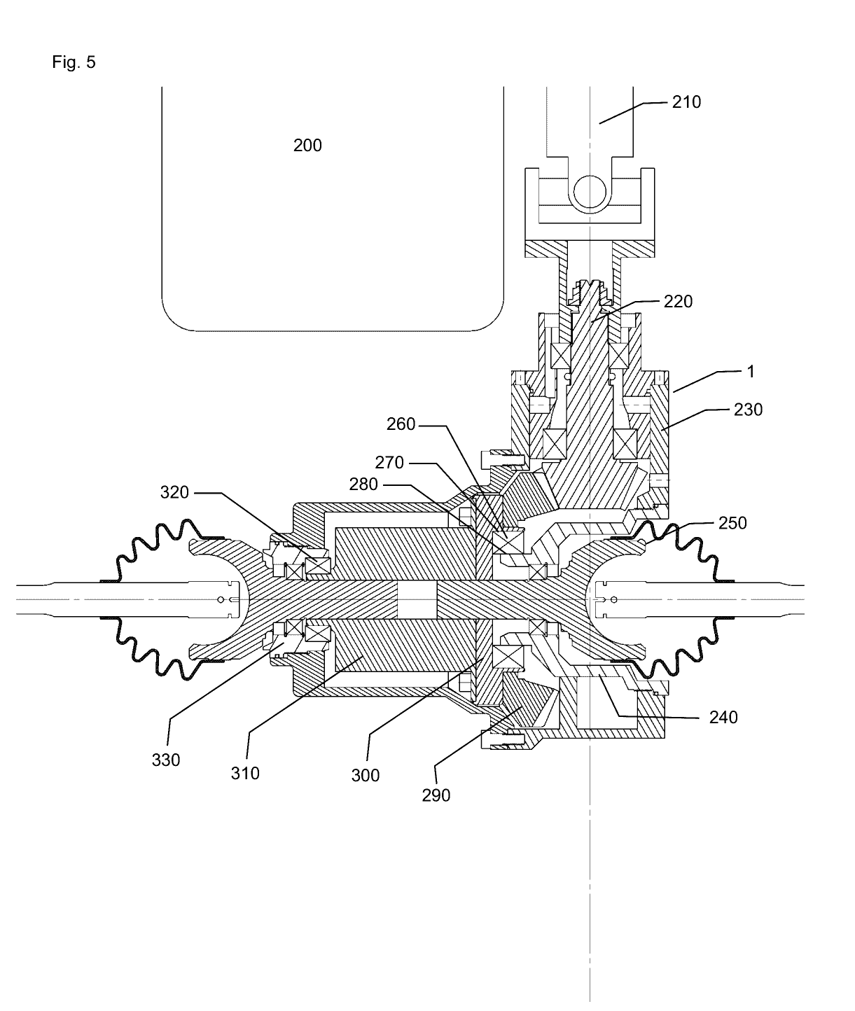

With differential housing design disclosed herein, it is possible to use a longer half shaft without changing the position of the engine and without changing the position of the central prop shaft. This result can be seen when comparing the typical arrangement shown in FIGS. 1-2 and the disclosed device shown in FIGS. 3-4.

The ability to use a longer half shaft facilitated by the disclosed device allows for an increased range in wheel travel. Furthermore, the use of a longer half shaft allows the constant velocity joints or the universal joints to operate with reduced angles as compared to what the operating angles would be with a short half shaft and identical wheel movement. The disclosed device reduces power loss, and the operating lifespan and fuel economy is increased. The longer half shaft of the disclosed device also increases torsional ductility which helps to protect the transmission.

1. A differential housing capable of accommodating a longer half shaft for connecting to an adjacent wheel, the differential housing comprising:
an enclosure to contain a differential,
the enclosure having a conically shaped component having a thread to regulate the tooth mesh of a crown wheel and pinion gears;
the conically shaped component mountable to an inner fixed ring of a tapered roller bearing;
an outer ring of the tapered roller bearing affixed to a crown wheel spacer; and
the differential mountable to a crown wheel by means of the spacer.

2. The differential housing of claim 1, wherein the conically shaped component is configured to connect to a constant velocity joint connection.

3. The differential housing of claim 1, wherein the conically shaped component is configured to connect to a universal joint connection.

4. The differential housing of claim 1 further comprising a half shaft.

5. A differential housing capable of accommodating a longer half shaft for connecting to an adjacent wheel, the differential having a crown wheel side, the apparatus comprising;
a housing;
a differential mountable to a tapered roller bearing by means of a spacer;
the tapered roller bearing having an outer rotating ring and a fixed inner ring;
the fixed inner ring mountable to a conically shaped component having a thread to regulate tooth mesh of a crown wheel and pinion gears;
the differential further mountable to the crown wheel by means of the spacer; and
the outer ring of the tapered roller bearing affixed to the housing by means of the spacer.

6. The differential housing of claim 5, wherein the conically shaped component is configured to connect to a constant velocity joint connection.

7. The differential housing of claim 5, wherein the conically shaped component is configured to connect to a universal joint connection.

8. The differential housing of claim 5 further comprising a half shaft.
